(19) United States
(12) Patent Application Publication
(10) Pub. No.: US 2026/0138058 A1
(43) Pub. Date: May 21, 2026

(54) DOMESTIC SWIMMING-POOL FILTER WITHOUT BACKWASHING

(71) Applicant: BLUE OCEAN POOL SYSTEM, S.L., Errentería (ES)

(72) Inventors: Miguel Joaquín Pueyo Zapata, Errentería (ES); Carlos Fidel Hagen, Alpedrete (ES); José Ramón Vázquez Pérez, Madrid (ES)

(73) Assignee: BLUE OCEAN POOL SYSTEM, S.L., Errentería (ES)

(21) Appl. No.: 19/422,521

(22) Filed: Dec. 17, 2025

(30) Foreign Application Priority Data
Nov. 18, 2024 (ES) 202430955

(51) Int. Cl. B01D 29/00; B01D 29/52; E04H 4/12

(52) U.S. Cl. CPC B01D 29/0095; B01D 29/52; E04H 4/1209

(57) ABSTRACT

Described herein is a domestic filter for swimming pools with no backwashing operation The filter includes a water inlet (4), a filtered-water outlet (5) and a top opening (2) with a watertight closure lid (3). The inlet is associated with a diffuser (6) that discharges water over the upper zone, in which a plurality of filtering elements, materialized as polymer-fibre spheres, rest on a separator plate (10) provided with a plurality of holes (11) that allow the filtered water to pass into a lower chamber in which the filtered-water outlet (5) is established, fitted with a threaded mesh screen filter. The separator plate (10) is foldable and removable through the top opening (2), for which purpose the diffuser (6) adopts an off-centre arrangement, thereby providing a structure that does not require backwashing operations for its maintenance.

### CROSS-REFERENCE TO RELATED APPLICATIONS

Benefit is claimed to Spanish Patent Application No. 202430955, filed on November 18, 2024, the contents of which are incorporated by reference herein in their entirety.

### FIELD OF THE INVENTION

The present invention relates to a domestic filter for swimming-pools, specifically designed to save water, such that it does not require the usual backwashing process, in which the water flow is reversed to remove some of the dirt accumulated in the filter.

The purpose of the invention is, therefore, to offer a filter that does not consume water during its cleaning operations, as the filter medium will be a recyclable, single-use compound that is replaced when the retained dirt renders it ineffective.

The internal cleaning of this filter will be performed easily, by means that allow access to its interior to remove the filter elements and clean the entire inside of the filter without having to dismantle it from the system to which it is connected.

The invention thus aims to provide a filter that is easy to maintain, reliable, lightweight, efficient in its function, and simpler by not requiring flow-reversing valves, thereby saving water during the filter cleaning process.

### BACKGROUND OF THE INVENTION

Although cartridge filters have existed in the market for many years, they represent a very small portion of installed systems due to their high maintenance costs, their suitability only for small pools, and the need for significant vertical clearance in filter rooms for their use.

This is due to the limitations of tanks that must be made of plastic to allow for mid-section opening and the cost of cellulose cartridges they contain, which are narrow, tall, expensive to manufacture, and delicate.

In the practical application field of the invention, sand filters are commonly used for both public and private pools. These operate similarly, with the main modes being filtration and backwashing.

In the filtration mode of the sand filter intended to be replaced by the present invention, water is pumped from the pool through a top-mounted component called a diffuser.

This water is pushed downward through the filter medium, typically sand or crushed glass in pools, which traps the dirt.

The filtered water exits the filter back to the pool through either collector arms (in domestic filters) or filter nozzles (also known as strainer nozzles) inserted into a fiberglass and polyester resin plate (in industrial filters).

Both the filter nozzles and the collector arms are plastic components with very fine slots that prevent sand or glass from escaping into the pool and are highly resistant to abrasion wear.

However, when the filter medium accumulates too much dirt, a backwashing process is initiated.

This process reverses the flow of water through the filter using multiport valves, so the water exits through the bottom (nozzles or collector arms), passes through the filter medium, dislodging the accumulated dirt, and is then drawn off out through the diffuser.

This dirty water is then directed to the drain instead of the pool until all the dirt is removed. At this point, the flow direction is reversed again to resume filtration.

This process leads to an undesired consumption of water.

Currently, there is another filter medium on the market as an alternative to sand or crushed glass. Due to its high filtration capacity (5 microns) and low weight (750 grams of fibres equivalent to 25 kg of sand according to some manufacturers), this medium takes the form of polymer-fibre spheres that allow for optimal filtration and can be easily replaced at the end of their service life.

However, this new filter medium presents significant issues in domestic filters, especially in large pools. When chemical products such as flocculants are used in the pool water, these polymer spheres tend to degrade over time due to the flocculant's effect, turning into a viscous mass that can pass through the filter and potentially clog other, less accessible parts of the pool system.

### SUMMARY

The domestic swimming-pool filter proposed herein fully addresses the problems set out above through a simple yet effective solution that avoids water consumption during cleaning. Cleaning is performed manually thanks to easy access to the interior, without removing the filter from the installation. This facilitates replacement of the filter elements and cleaning of any debris that may settle at the bottom of the filter, rendering the unit more effective, more economical, longer-lasting, and much easier to maintain.

For this purpose, the filter of the invention is formed by a hermetically sealed housing that includes two lateral openings providing, respectively, an inlet for the water to be filtered and an outlet for the filtered water. The inlet is connected to a diffuser that is arranged in an off-centre position in order to facilitate maintenance operations, as will be explained below.

More specifically, two vertically delimited chambers are defined within the housing that constitutes the main body of the filter: an upper zone in which the above-mentioned diffuser is located, through which the water to be filtered enters, and a lower zone where the filtered water is collected before being discharged from the filter.

These two zones are separated by an separator plate provided with a plurality of perforations through which the filtered water can pass. The separator plate is foldable and rests on a central pillar to which it is secured by a locking nut on the threaded end of the central pillar.

Polymer-fibre spheres that act as filter elements for the incoming water are placed on this plate, such that, once filtered, the water passes through the plate and reaches the lower chamber, from which the outlet conduit of the filter leads.

As stated earlier, experimental evidence has shown that the use of flocculants and other chemical products in pool water degrades, over time, the polymer-fibre spheres acting as filter elements, producing a viscous mass that may pass through the plate separating the upper and lower chambers. To prevent this viscous fluid from clogging the piping of the installation, the water outlet port is fitted with a threaded mesh screen that blocks the passage of this by-product.

In existing sand filters there is no filter/mesh screen at the filtered-water outlet, since both the filter nozzles and the collector arms are themselves filters; adding a further filter/mesh screen would not add value.

In the present filter, however, the outlet screen filter is threaded and therefore readily interchangeable or removable for cleaning.

To this end, the main body of the filter is provided at the top with a top opening provided with a watertight lid that allows manual access to the interior. Through this opening the filtering spheres can be removed and access can be gained to the bottom of the main body to clean any sediments that may have accumulated there. As indicated above, the separator plate is foldable so that it can be extracted through the upper lid without having to dismount the filter from the installation.

In this way, it is possible to replace the filter elements without consuming water, as well as to clean or replace the support plate for those elements. It also allows cleaning of the lower part of the filter and the screen fitted at the water outlet of the filter, without having to remove the unit from the installation.

### BRIEF DESCRIPTION OF THE DRAWINGS

To complement the description that follows and to aid a better understanding of the features of the invention, and in accordance with a preferred practical embodiment thereof, a set of drawings is appended as an integral part of this description, in which, by way of illustration and without limitation, the following is shown:

FIG. 1 is a perspective view of a domestic swimming-pool filter constructed in accordance with the object of the present invention.

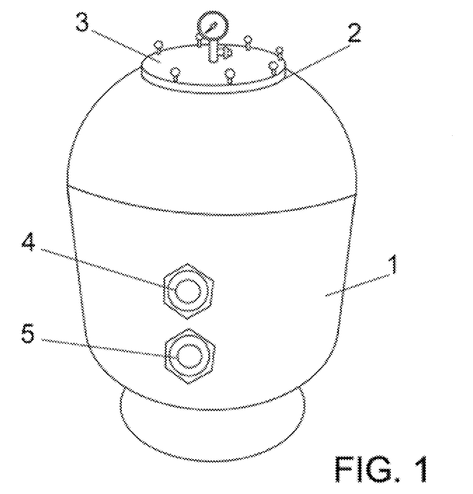

FIG. 2 is a perspective detail view of the internal elements of the filter, shown without its foldable separator plate that divides the two working zones of the filter.

FIG. 3 is a perspective detail view of the interior of the filter with the foldable plate mounted on its central pillar, the stabilizing nut that secures said plate to the pillar being shown in broken lines.

FIG. 4 is a view like that of FIG. 1, with the top lid removed, showing that the foldable plate which delimits the two working zones of the filter is readily extractable through the opening of said lid by virtue of its foldable nature.

### DETAILED DESCRIPTION

In view of the referenced figures, it can be observed that the domestic swimming‑pool filter of the present invention is formed from a hermetically sealed housing (1), in which a top opening (2) is defined, provided with a watertight closure lid (3). The housing includes a water inlet (4) for the water to be filtered and a water outlet (5) for the filtered water.

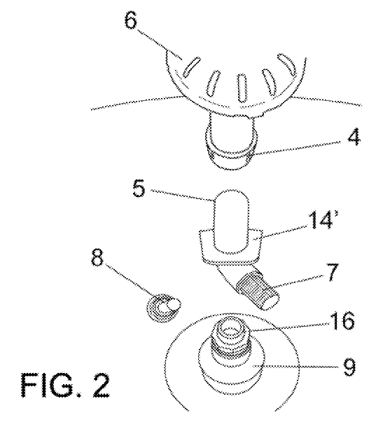

More specifically, and as can be seen in FIG. 2, the water inlet (4) is connected to a diffuser (6) that is offset with respect to the vertical axis of symmetry of the filter, located near its side wall to facilitate maintenance operations, causing the water to enter the main body of the filter through its upper zone.

The water outlet (5) is arranged at the lower part of the main body of the filter and is provided with a removable threaded mesh screen (7), preferably screw‑in/threaded.

At the bottom of said main body there is a drain port (8), as well as a central pillar (9) in which a seat is defined for a separator plate (10) made of polypropylene or another plastic material, the plate having a plurality of holes (11) of a width consistent with the filtration grade intended for the device.

This plate divides the main body of the filter into two zones: an upper zone in which the above‑mentioned diffuser is located, through which the water to be filtered enters, and where a plurality of polymer‑fibre spheres are arranged that act as filter elements for the incoming water, such that, once filtered, the water passes through this separator plate (10) and reaches the lower chamber, from which the water outlet conduit (5) is established.

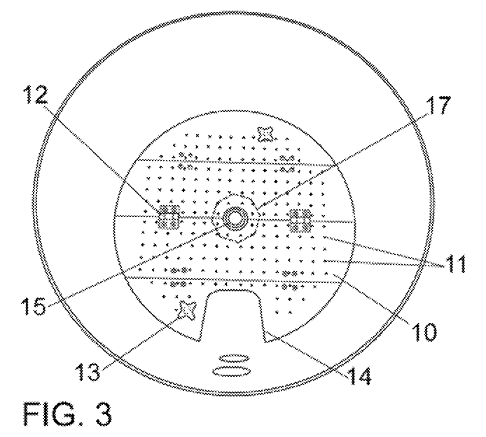

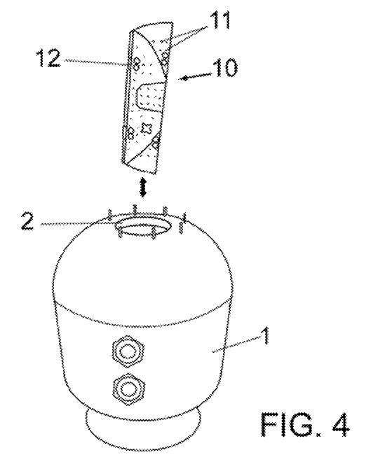

As shown in FIGS. 3 and 4, the separator plate (10) has a disc‑shaped configuration and is divided into several pieces linked to one another by hinges (12) that facilitate folding, which can be carried out without dismantling the filter, simply by removing its top lid (3).

The plate will include handles (13) to facilitate handling, a U‑shaped notch (14) for the passage of the conduit associated with the water outlet (5), which is linked to a likewise U‑shaped flat bar (14') that fits in said notch.

This plate likewise includes a central hole (15) for the passage of the threaded end (16) of the central pillar (9), onto which a locking nut (17) will be screwed, shown in broken lines in FIG. 3.

Based on this structure, and as mentioned above, water enters the upper chamber of the filter through the diffuser (6), is filtered by the polymer‑fibre spheres (not shown in the figures as they are conventional, commercially available elements), such that, once filtered, the water passes through the holes (11) of the separator plate (10) and is extracted through the water outlet (5).

When the filter elements become clogged, it suffices to remove the lid (3) to replace them manually, and the separator plate (10) can likewise be extracted once its nut (17) fastening it to the central pillar (9) has been removed, by folding the plate as shown in FIG. 4, which also allows access to the bottom of the filter to remove possible sediments that may have formed in the event flocculants are used in the water, flocculants which, as stated above, degrade the polymer‑fibre spheres, generating a viscous residue that is prevented from leaving said chamber thanks to the threaded mesh screen (7) mounted on the water outlet; the threaded mesh screen (7) can be readily replaced or removed for cleaning by virtue of its threaded nature.

Lastly, it should be noted that, since the diffuser (6) is offset and the separator plate (10) includes a U‑shaped notch (14), this component does not constitute an obstacle when folding and removing the separator plate (10).

1. A domestic swimming‑pool filter with no backwashing operation, being of the type that incorporates a hermetically sealed housing (1) including a water inlet (4) for the water to be filtered and a water outlet (5) for the filtered water, as well as a top opening (2) provided with a watertight closure lid (3), the water inlet (4) being associated with a diffuser (6) that discharges the incoming water over the upper zone of the housing, in which a plurality of filter elements are provided, materialized as polymer‑fibre spheres resting on a separator plate (10) of polyethylene or another plastic material, the plate having a plurality of holes (11) that allow the filtered water to pass into a lower chamber in which the filtered‑water outlet (5) is established, wherein the separator plate (10) is foldable and removable through the top opening (2) in a folded arrangement, for which purpose the diffuser (6) adopts an off‑centre disposition.

2. The domestic swimming‑pool filter with no backwashing operation according to claim 1, wherein the water outlet (5) includes a removable threaded mesh screen (7), preferably threaded.

3. The domestic swimming‑pool filter with no backwashing operation according to claim 1, wherein at the bottom of the hermetically sealed housing there is a central pillar (9) in which a seat is defined for the separator plate (10), which is stabilized on said pillar by means of a locking nut (17) adapted to a threaded end (16) provided on the central pillar (9) and passing through a hole made in the separator plate (10).

4. The domestic swimming‑pool filter with no backwashing operation according to claim 1, wherein the separator plate (10) has a disc‑shaped configuration and is divided into several pieces linked to one another by hinges (12), including handles (13) for handling, and a U‑shaped notch (14) for the passage of the conduit associated with the water outlet (5), which is linked to a likewise U‑shaped flat bar (14') that fits into said notch.

5. The domestic swimming‑pool filter with no backwashing operation according to claim 3, wherein the separator plate (10) has a disc‑shaped configuration and is divided into several pieces linked to one another by hinges (12), including handles (13) for handling, and a U‑shaped notch (14) for the passage of the conduit associated with the water outlet (5), which is linked to a likewise U‑shaped flat bar (14') that fits into said notch.
